(19) United States
(12) Patent Application Publication
(10) Pub. No.: US 2026/0022932 A1
(43) Pub. Date: Jan. 22, 2026

(54) DEVICE FOR CHROMATIC CONFOCAL MEASUREMENT OF DISTANCES

(71) Applicant: PRECITEC OPTRONIK GMBH, Neu-Isenburg (DE)

(72) Inventors: Laura Vietze, Darmstadt (DE); Christoph Dietz, Obertshausen (DE); Frauke Roellinghoff, Frankfurt (DE)

(21) Appl. No.: 18/993,512

(22) PCT Filed: Jun. 28, 2023
(86) PCT No.: PCT/EP2023/067657

§ 371 Date: Jan. 10, 2025

(30) Foreign Application Priority Data
Jul. 13, 2022 (DE) 10 2022 117 536.7

(51) Int. Cl. G01B 11/24; G01B 11/02

(52) U.S. Cl. CPC G01B 11/24; G01B 11/026

(57) ABSTRACT

A device is for chromatic confocal measurement of distances to a plurality of points on a reflective surface of an object. The device has a light source that generates polychromatic measurement light and a light pattern generating device that generates a light pattern from the measurement light. A chromatically uncorrected objective generates images of the light pattern in image planes whose axial position is wavelength-dependent due to chromatic longitudinal aberration. The device further comprises a spectrometer, which spectrally analyzes measurement light reflected from the surface, and a pixel-wise digitally switchable spatial filter which has a plurality of pixels and either forms the light pattern generating device or is arranged in a plane optically conjugate to the static spatial filter. Each pixel can be converted into a first switching state, in which the pixel blocks measuring light. and into a second switching state, in which the pixel does not block measuring light.

### CROSS-REFERENCE TO RELATED APPLICATIONS

This application is a U.S. national stage of International Application No. PCT/EP2023/067657 filed Jun. 28, 2023, which claims the benefit of and priority to earlier German Application No. 10 2022 117 536.7 filed Jul. 13, 2022. The entire disclosures of these earlier filed applications are hereby incorporated by reference as if fully set forth herein.

### BACKGROUND OF THE DISCLOSURE

### 1. Technical Field

The present disclosure relates to a device for chromatic confocal measurement of distances at several points, in one example arranged along a line, on surfaces of workpieces and other objects.

### 2. Description of the State of the Art

Devices for the chromatic confocal measurement of distances have been used in industrial metrology for many years when distances to workpieces or other objects need to be measured without contact and with high accuracy. With transparent objects, such devices can also be used to measure wall thicknesses or other thicknesses, as a distance can usually be determined for each optical interface and the thickness is calculated as the difference between the measured distances.

Conventional devices for chromatic confocal measurement of distances contain a light source that generates polychromatic measuring light and directs it onto a pinhole diaphragm that has a very small aperture. The aperture is imaged onto the surface to be measured by imaging optics. At least part of the imaging optics exhibits significant longitudinal chromatic aberration. Different colored images of the aperture are therefore arranged one behind the other on the optical axis of the imaging optics. Only the spectral component of the measuring light, in which the image of the aperture lies exactly on the surface to be measured, is reflected back by the surface in such a way that it can enter the same aperture or an aperture arranged optically conjugate to it. The wavelength of this spectral component is measured using a spectrometer. Each wavelength is assigned a specific distance from the imaging optics.

Although the other spectral components are also partially reflected by the object surface, they cannot be focused by the imaging optics into the same or an optically conjugated aperture and therefore do not contribute significantly to the part of the measured light that is spectrally analyzed by the spectrometer.

From U.S. Publication No. 2018/0038680, a chromatic confocal measuring device is known that can be used to measure the distances or thicknesses at several points simultaneously. The otherwise conventional pinhole diaphragm is replaced here by a linear or planar arrangement of the ends of optical fibers. If the distances or thicknesses are measured simultaneously at several points, this considerably shortens the measuring time. A complete surface profile can then be created in a short time, even for larger surfaces.

The lateral resolution of such a multi-point measuring device, i.e. the density of the measuring points on the surface of the object, is limited by the fact that measuring light reflected from the object that impinges on the end of an optically conjugated optical fiber must not hit an adjacent optical fiber at the same time. If such optical crosstalk occurs, it is no longer possible to assign clear distance values to the individual measuring points. One of the factors contributing to optical crosstalk is that, for physical reasons, the image of a fiber end can never be exactly sharp, even with optimally corrected imaging optics, but due to diffraction phenomena has the form of a flat, extended diffraction disc that has several clearly recognizable secondary maxima.

In the known devices for chromatic-confocal multi-point measurement, the fiber ends are therefore relatively far apart, which is why a high density of measuring points is not possible.

### SUMMARY OF THE DISCLOSURE

The object of the disclosure is to provide a device for chromatic confocal measurement of distances to several points on a surface of an object, which has a high lateral resolution.

According to the disclosure, this object is achieved by a device for chromatic confocal measurement of distances at several points on a surface of an object, comprising a light source configured to generate polychromatic measuring light. A light pattern generating device is configured to generate a light pattern from the measurement light, which extends in a first plane along one dimension or along two dimensions. A chromatically uncorrected objective is configured to generate images of the light pattern in image planes whose axial position is wavelength-dependent due to chromatic longitudinal aberration. A static spatial filter is arranged in a second plane and has a filter function corresponding (but not necessarily identical) to the light pattern, wherein the second plane is optically conjugate to the first plane. A non-polarizing beam splitter cube, in one example, is arranged in the light path between the light pattern generating device and the objective and directs measurement light, which has been reflected from the surface and has passed through the objective, to the spatial filter. A spectrometer comprises several input channels, which are configured to spectrally analyze reflected measurement light, which has passed through a point of the static spatial filter assigned to the respective input channel. An evaluation device is configured to calculate distances from points on the surface to the measuring device from wavelengths measured by the spectrometer. In an embodiment, the device also comprises a pixel-wise digitally switchable spatial filter, which has a plurality of pixels and either forms the light pattern generation device or is arranged in a third plane, which is optically conjugate to the first plane and the second plane, wherein each pixel can be converted into a first switching state, in which the pixel blocks measuring light, and into a second switching state, in which the pixel does not block measuring light.

The pixel-wise digitally switchable spatial filter makes it possible, at one time during the measurement, to obstruct a part of the measurement light, which would lead to optical crosstalk, or deflect it so that it cannot reach the spectrometer. At another time, another part of the measurement light is suppressed. In this way, a very high lateral resolution can be achieved by combining several successive measurements.

In the simplest case, pixel-wise digitally switchable spatial filter is controlled in such a way that it switches between a first switching configuration and a second switching configuration during a measurement, wherein in the first switching configuration no two adjacent pixels are in the same switching state, and whereby the second switching configuration is complementary to the first switching configuration. This means that only two individual measurements are required.

In order to achieve even higher lateral resolutions, it may be necessary for the distances between the active pixels to be greater, so that at least n=2, 3, . . . pixels are in an inactive switching position for each switching configuration between two active pixels. Accordingly, n+1 different switching configurations must then follow one another until all pixels have been in an active switching position once.

The control with different switching configurations can be made dependent not only on the required lateral resolution, but also on the properties of the object surface to be measured. For surfaces where the signal-to-noise ratio is favorable, more crosstalk can be tolerated if necessary, so that half or even all of the pixels of the spatial filter can be in the active second switching state at a given time. The more disruptive the crosstalk is, the greater the distance between pixels in the active second switching state should be at a given time.

The optical conjugation between the third plane, in which the pixel-wise digitally switchable spatial filter is located, and the first plane, in which the light pattern generation unit is located, ensures that pixels of the pixel-wise digitally switchable spatial filter can be clearly assigned to the individual measuring points. Optically conjugated planes are planes that can be transformed into one another by means of optical imaging. As a rule, there is therefore an objective having one or more lenses or mirrors between two optically conjugated planes, which produces the optical image. However, instead of objectives, optical conjugation can also be achieved by other optical systems in special cases. One example of this is the opposite ends of optical fibers, which can both be regarded as optically conjugated, as the point-like light distribution is identical at both ends. Bundles of optical fibers can therefore also be used to create optical images, as is known from endoscopes, for example. Two planes lying directly behind each other can also be regarded as optically conjugated in a broader sense.

If the pixel-wise digitally switchable spatial filter is arranged independently of the light pattern generating device and in the third plane, it can be located in the light path between the light pattern generating device and the beam splitter cube. Such an arrangement is favorable because the image of the light pattern is sharper than after re-imaging through the objective.

In one example, the device then has imaging optics, which image the first plane onto the third plane. Such imaging optics are particularly advantageous if the light pattern generating device comprises an arrangement of ends of optical fibers or an diaphragm with at least one aperture. The measuring light usually emerges from the fibers or the aperture in a strongly diverging manner. If the pixel-wise digitally switchable spatial filter is arranged directly at the fiber ends or in front of the opening of an aperture, optical conjugation in the broader sense is provided. However, many particularly suitable pixel-by-pixel digitally switchable spatial filters, such as micromirror arrays, cannot be arranged so close to the light pattern generation device that one can still speak of optical conjugation. On the one hand, the imaging optics allow the use of a large numerical aperture and, on the other hand, the use of micromirror arrays and other switchable spatial filters, which can only be arranged at a greater distance from the light pattern generation device due to beam folding or the required installation space.

The light pattern can comprise several two-dimensionally distributed light points or at least one continuous light line or a light line composed of light points. The division of a continuous light line into individual measuring points is achieved by the pixels of the switchable spatial filter.

In one embodiment, the light pattern generation device comprises a planar arrangement of micro converging lenses. The converging lenses focus the measuring light onto the respective assigned pixels of the switchable spatial filter, thereby effecting optical conjugation in the broader sense.

In another embodiment, the pixel-wise digitally switchable spatial filter forms the light pattern generation device. Such a setup is particularly simple and allows the use of spatial filters in the form of micromirror arrays without the need for additional imaging optics.

The spatial filter should then be illuminated with light that has an angular distribution that is matched to the numerical aperture of the chromatically uncorrected objective. This works particularly well if the measuring light spreads out as a free beam between the light source and the pixel-wise digitally switchable spatial filter.

To avoid light losses, the spatial filter, which acts as a light pattern generating device, should be illuminated by the light source in such a way that as much light as possible impinges on the spatial filter. Depending on the type of light source, a simple converging optics is sufficient to focus the light emitted from an exit surface of the light source so that it impinges on the spatial filter with minimal loss. If the light pattern generated by the spatial filter comprises a light line composed of several light points, the converging optics can be a cylindrical lens or otherwise anamorphic.

In one embodiment, a collimator is arranged in the light path between the light pattern generation device and the beam splitter cube, which collimates the measuring light entering the beam splitter cube. Due to the confocal imaging, the measuring light reflected by the object then also passes through the beam splitter cube in collimated form. Collimated transmission is advantageous because the beam splitter cube then does not generate any spherical aberration.

The pixel-wise digitally switchable spatial filter may be a micromirror array. Alternatively, it can also be a transmissive MEMS component as described, for example, in U.S. Pat. No. 8,054,527. An LCD panel can also be considered as a pixel-wise digitally switchable spatial filter, but has disadvantages due to its polarizing properties.

For the same reason, it is useful if the beam splitter cube is non-polarizing. The splitting ratio of the beam splitter cube then does not depend on the polarization state and thus on the properties of the object surface.

In one embodiment, the polychromatic light source contains a luminophore, as is known from U.S. Pat. No. 10,731,965. In one example, such a light source has an elongated light-emitting surface. If optical fibers are used for light transmission, their ends can form a rectangular or circular arrangement and receive light, which is emitted from an adjacent square or circular light-emitting surface of the luminophore.

In a luminophore-based light source, a pump source, which is usually a laser or an LED, is used to excite a phosphor known as a luminophore, which emits light through a physical process, in particular phosphorescence, fluorescence or scintillation. The advantage of such a light source is that it can illuminate the entire confocal aperture and has a high efficiency and high luminous efficacy.

In order to reduce optical crosstalk due to stray light or similar, further spatial filters can be arranged at positions that are optically conjugate to the first, second and third planes.

The spectrometer can be synchronized with the pixel-wise digitally switchable spatial filter in such a way that input channels that are assigned to pixels in the second switching state are logically or physically deactivated. This prevents measurement light that reaches neighboring input channels as a result of crosstalk from being taken into account during evaluation. The easiest way to deactivate the relevant input channels is to ensure that the intensities recorded there are not read out.

If the pixel-wise digitally switchable spatial filter is arranged in the light path between the light source and the beam splitter cube, a further pixel-wise digitally switchable spatial filter can be arranged in the light path between the beam splitter cube and the spectrometer in a fourth plane, which is optically conjugate to the first plane and the second plane. Each pixel of the further pixel-wise digitally switchable spatial filter can be transferred into a first switching state, in which the pixel blocks measuring light, and into a second switching state, in which the pixel does not block measuring light.

The background to this measure is that the image of the light pattern loses sharpness with each optical imaging. If, for example, two neighboring diffraction disks overlap only negligibly on the object surface, the overlap can already be significant after re-imaging through the lens at the height of the spectrometer. The additional pixel-by-pixel digitally switchable spatial filter can remedy this by trimming the relevant light beams again so that no crosstalk occurs at the spectrometer even after re-imaging.

### BRIEF DESCRIPTION OF THE DRAWINGS

In the following, embodiments of the disclosure are explained in more detail with reference to the drawings. In the drawings:

FIG. 1 shows a device according to the disclosure for distance measurement according to a first embodiment in a schematic meridional section;

FIG. 2 shows a top view of a pinhole diaphragm used as a light pattern generating device in the device shown in FIG. 1;

FIGS. 3a and 3b show a transmissive MEMS spatial filter contained in the device shown in FIG. 1 in an enlarged schematic section in different switching configurations;

FIG. 4 shows a plan view of another embodiment of a pinhole diaphragm, which can be used as a light pattern generating device in the device shown in FIG. 1;

FIG. 5 shows a plan view of a further embodiment of a pinhole diaphragm, which can be used as a light pattern generating device in the device shown in FIG. 1;

FIG. 6 shows a device according to the disclosure for distance measurement according to a second embodiment in a schematic meridional section;

FIGS. 7a and 7b show a reflective MEMS spatial filter contained in the device shown in FIG. 6 in an enlarged schematic section in different switching configurations;

FIG. 8 shows a schematic representation of an embodiment, in which the light pattern generating device is formed by a linear arrangement of microlenses;

FIGS. 9a and 9b show further possibilities for possible switching configurations in schematic representations based on FIGS. 3a and 3b;

FIG. 10 shows a section of a further variant with two transmissive MEMS spatial filters; and

FIG. 11 shows a device for distance measurement according to the disclosure in accordance with a third embodiment in a schematic meridional section, in which the pixel-wise digitally switchable spatial filter forms the light pattern generating device.

### DESCRIPTION OF EMBODIMENTS

### 1. Design of the Measuring Device

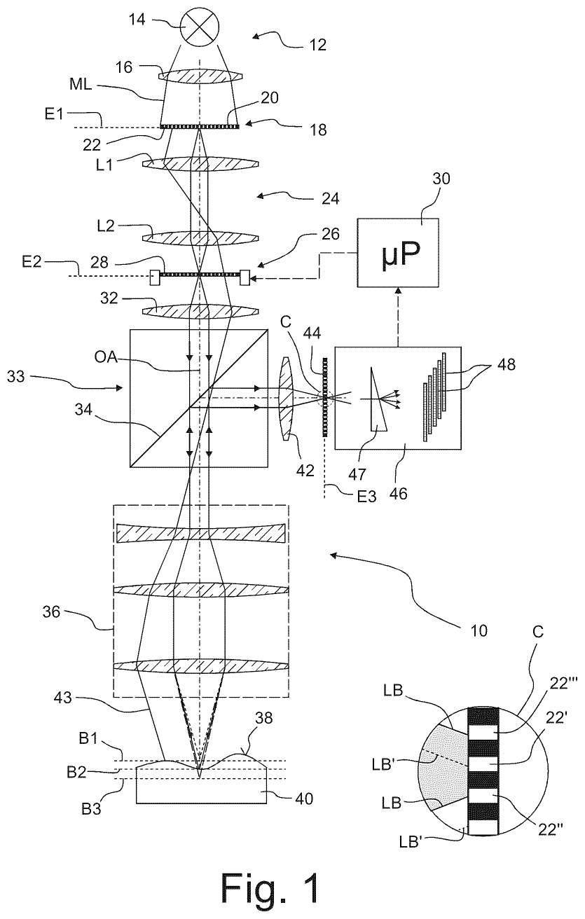

FIG. 1 shows a device for distance measurement according to the disclosure, designated overall by 10, in a schematic meridional section according to a first embodiment.

The device 10 has a light source 12 that generates polychromatic measuring light ML. The measuring light ML may have a continuous spectrum. However, the use of comb spectra or other discrete spectra can be considered in principle, provided that the wavelength peaks are sufficiently close together. In the embodiment shown, the light source 12 comprises a superluminescent diode 14 and a converging lens 16 arranged behind it in the direction of light propagation.

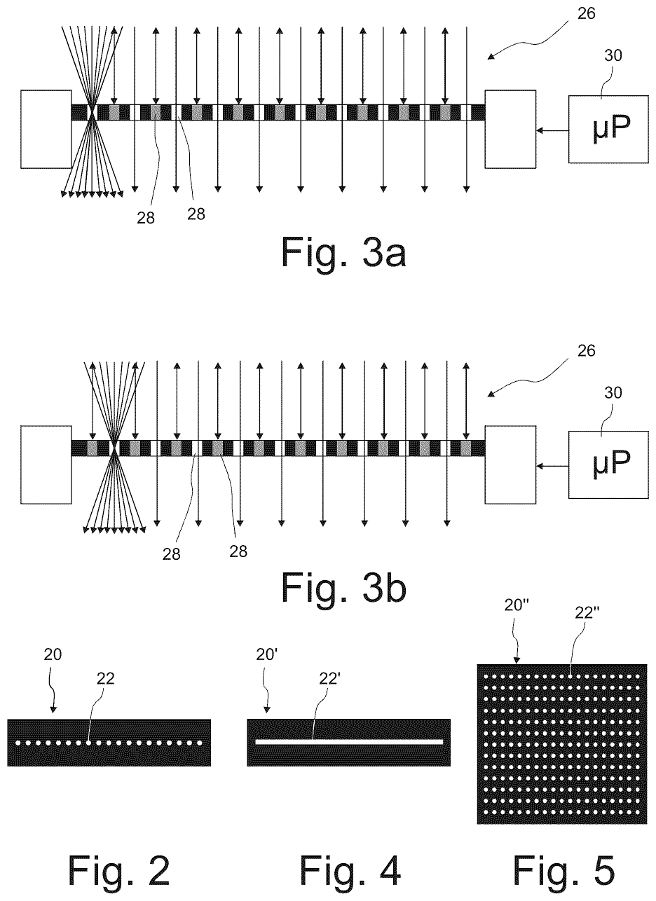

The measuring light ML generated by the light source 12 strikes a light pattern generating device 18, which generates a light pattern from the incident measuring light ML. In the embodiment shown, the light pattern generating device 18 comprises a pinhole diaphragm 20, which is shown in plan view in FIG. 2. The pinhole diaphragm 20 has several apertures 22, which are arranged along a line. When illuminated with the measuring light ML, the apertures 22 represent point light sources from which the measuring light ML emerges divergently.

The apertures 22 are arranged in a first plane E1, which coincides with an object plane of imaging optics 24. In the illustrated embodiment, the imaging optics 24 is designed as a 4f optics. Such 4f optics is characterized by the fact that two objectives or lenses L1, L2 are arranged in such a way that the rear focal plane of lens L1 coincides with the front focal plane of lens L2. This leads to a telecentric beam path on both sides with the result that the angular distribution at the apertures 22 is transferred to the image plane E2 of the imaging optics 24 without tilting. If the focal length of the lenses L1 and L2 is the same, as in the embodiment shown, the magnification β=−1.

A transmissive MEMS spatial filter 26 is arranged in the image plane E2 of the imaging optics 24, where MEMS is an acronym for micro-electro-mechanical system. Such filters 26 comprise a plurality of regularly arranged elements or pixels 28, which can be individually mechanically moved to selectively unblock or block the light path. Suitable examples of such MEMS filters are known per se and are described, for example, in US 2006/0012781 A1. Alternatively, an LCD panel can also be used, although this has a polarizing effect, which can be disadvantageous for some measurement tasks.

FIGS. 3a and 3b show the transmissive MEMS spatial filter 26 in an enlarged schematic section. In the illustrated embodiment, the pixels 28 of the transmissive MEMS spatial filter 26 are arranged along a line in such a way that each pixel 28 is assigned exactly one aperture 22 of the light pattern generating device 18. This assignment results from the mapping of the apertures 22 onto the pixels 28 effected by the imaging optics 24.

The individual switchability of the individual pixels 28 is indicated in FIG. 3a by light and dark background colors. A pixel 28 with a dark background color is in a first switching state in which the pixel 28 blocks measuring light ML. A pixel 28 with a light background color is in a second switching state in which the pixel 28 is transparent for measuring light. The switching states of the pixels 28 are specified by a control and evaluation device 30. The change between different switching states, as can be seen from a comparison of FIGS. 3a and 3b, typically takes place within a few microseconds.

For the pixel 28 shown on the far left in FIG. 3a, which is in the second switching state, it is indicated by further rays that the angular distribution of the measurement light ML is maintained when it passes through the transmissive MEMS spatial filter 26. The transmissive MEMS spatial filter 26 thus only filters in spatial space, but not in angular space. Consequently, the measured light ML emerges at the output of the pixel 28 with the numerical aperture NA of the imaging system 24.

The pixels 28 of the transmissive MEMS spatial filter 26 thus also represent point light sources, but in contrast to the apertures 22 of the light pattern generating device 18, they can be switched on and off individually.

FIGS. 3a and 3b illustrate two different switching configurations between which it is possible to switch in this embodiment. In the first switching configuration, which is shown in FIG. 3a, no two adjacent pixels 28 are in the same switching state. The switching state therefore alternates from pixel to pixel. The second switching configuration shown in FIG. 3b is complementary to the first switching configuration in FIG. 3a. Consequently, there are also no two adjacent pixels 28 in the same switching state, which alternates from pixel to pixel. However, the switching pattern is offset by one pixel, so that it is possible to switch between the two switching configurations shown in FIGS. 3a and 3b by switching to the other switching state for each pixel 28. The advantages associated with the transmissive MEMS spatial filter 26 and the change of switching configurations are explained below in section 2.

A collimator lens 32 is arranged in the light path behind the transmissive MEMS spatial filter 26, the front focal plane of which coincides with the plane E2. The beams emerging from the pixels 28 are therefore collimated as they pass through the collimator lens 32.

The collimated beams hit a non-polarizing beam splitter cube 33, which has a beam splitter surface 34 inclined at 45° to the optical axis. A predetermined proportion of the incident light, e.g. 50%, is reflected at the beam splitter surface and is lost for the measurement. The remaining measuring light ML passes through the beam splitter cube without deflection due to the collimated beam path and strikes a chromatically uncorrected objective 36, which has an object plane lying at infinity. Together with the imaging optics 24 and the collimator lens 32, the objective 36, due to its chromatic longitudinal aberration, images the apertures 22 arranged in the plane E1 in image planes B1 to B3, the axial positions of which are wavelength-dependent. In FIG. 2, this is indicated by different dashes.

Each wavelength is assigned exactly one image plane. If—as in the present embodiment—the spectrum generated by the light source 12 is continuous, this results in a continuous sequence of image planes.

If the image of an aperture 22 lies in an image plane at the height of which an at least partially reflective surface 38 of an object 40 is located, the light beam impinging there is reflected back into itself and travels along the same path via the objective 36 back to the beam splitter surface 34 of the beam splitter cube 33. For the constellation shown here, this condition is fulfilled, for example, for the aperture 22 lying on the optical axis OA of the device 10 at a wavelength for which the image of the aperture 22 lies in the image plane B2. For the light beam 43, which has passed through another aperture 22, this condition is fulfilled for the object 40 assumed here at a different wavelength, for which the image of the relevant aperture 22 lies in the image plane B1. Of course, not only light of a single wavelength is reflected at the surface 38. However, there is only one wavelength at which the measuring light beam is reflected in itself, because the focus is only exactly on the surface 38 for this wavelength.

At the beam splitter surface 34, a predetermined proportion of the reflected measuring light ML is reflected by 90° and focused by a converging lens 42 onto a static spatial filter 44, which is arranged in a third plane E3 and has a filter function corresponding to the light pattern. The static spatial filter 44 is permeable to measuring light ML at individual locations (or reflective in the case of a reflective spatial filter), while it blocks the measuring light ML at the other locations. In the simplest case, the static spatial filter 44 is the same pinhole diaphragm that was used for the light pattern generating device 18, possibly reduced or enlarged by the magnification of the intervening optics. This is because all of the optics in the light path between the light pattern generating device 18 and the static spatial filter 44, i.e., the imaging optics 24, the collimating lens 32, the objective 36, and the converging lens 42, cause the light pattern generating device 18 to be imaged onto the static spatial filter 44. The planes E1, E2 and E3 are therefore optically conjugate. Intermediate images are formed at the level of the transmissive MEMS spatial filter 26 and in the image planes B1 to B3 on the surface 38 of the object 40.

The static spatial filter 44 ensures that only measuring light beams that have been reflected at the surface 38 with a very specific wavelength can be further evaluated. Measurement light ML that does not fulfill this condition is obstructed by the static spatial filter 44 in accordance with the chromatic-confocal measurement principle.

A spectrometer 46 with several input channels is arranged in the light path behind the static spatial filter 44, which spectrally analyzes the reflected measurement light ML that has passed through a point of the static spatial filter 44 assigned to the respective input channel. The spectrometer 46 typically contains a dispersive optical element, e.g. an optical grating or a prism 47, and for each input channel a line-like arrangement 48 of light-sensitive cells, as schematically indicated in FIG. 1. Since spectrometers 46 of this type are known per se, further explanations are unnecessary at this point.

### 2. Function

During a measurement, the control and evaluation device 30 calculates distances from points on the surface 38 to the measuring device 10 from wavelengths measured by the spectrometer 46, as is known per se for chromatic confocal measuring devices. These points are images of the point light sources, i.e. the apertures 22. Each point light source is assigned its own input channel, so that the distance measurement can in principle be carried out simultaneously for all point light sources.

However, simultaneous distance measurement for all point light sources can result in optical crosstalk if the point light sources are very close together. The reason for this is that, even with optimum optical imaging, the images of the point light sources are blurred due to diffraction and can therefore overlap. This is shown schematically in the enlarged section C of the static spatial filter 44. In section C, it can be seen that the light beam LB highlighted in grey in plane E3 is not focused on a single aperture 22′, but also partially extends across the two adjacent apertures 22″, 22′″. Measurement light ML entering the wrong apertures 22″, 22′″ would be detected by the corresponding input channels of the spectrometer 46 and falsify the distance measurement. For example, not only a light beam LB′ indicated by dashed lines would fall into the aperture 22′″, but also the light beam LB in part.

The optical crosstalk could be prevented by increasing the distances between the point light sources (i.e. in this case the apertures 22). However, this measure would be at the expense of the lateral resolution of the device 10.

The control and evaluation device 30 therefore controls the transmissive MEMS spatial filter 26 in such a way that the measurement is divided into two partial measurements. In the first partial measurement, the pixels 28 of the transmissive MEMS spatial filter 26 are in one of the two switching configurations shown in FIGS. 3a and 3b. In the second partial measurement, the pixels 28 are in the other switching configuration. For the neighboring light bundle LB′, which is indicated by dashed lines in section C of FIG. 1, this means that it is prevented from propagating by the transmissive MEMS spatial filter 26 and cannot enter input channels of the spectrometer 46 that are not assigned to this light bundle LB′; this applies accordingly to the other light bundle, which is not indicated in section C and is neighboring the light bundle LB on the other side.

At the same time, the spectrometer 46 is synchronized with the pixel-wise digitally switchable spatial filter 26 in such a way that the two input channels assigned to the adjacent apertures 22″ are deactivated. The portion of the light beam LB that falls on the light-sensitive cells of these two input channels is therefore not evaluated.

By splitting the measurement into two individual measurements, between which the switching configurations shown in FIGS. 3a and 3b are alternated, optical crosstalk is effectively prevented. As a result, a high lateral resolution can be achieved with an approximate doubling of the measurement duration. The control and evaluation device 30 can be programmed in such a way that this mode is only used for measurements where a high lateral resolution is required and the object has a surface that is particularly conducive to optical crosstalk. If the lateral resolution requirements are lower, only one measurement is carried out with one of the switching configurations shown in FIGS. 3a and 3b.

### 3. Further Embodiments

FIG. 4 shows a slot aperture 20′ with a slot-shaped aperture opening 22′, which can be used as a light pattern generating device 18 as an alternative to the pinhole diaphragm 20 shown in FIG. 2. Measurement light ML, which would lead to optical crosstalk, is also prevented from propagating here with the aid of the transmissive MEMS spatial filter 26.

FIG. 5 shows a 2D pinhole diaphragm 20″ in a representation based on FIGS. 2 and 3, which can also be used as an alternative to the pinhole diaphragm 20 shown in FIG. 2 as a light pattern generating device 18. The apertures 22″ of the 2D pinhole diaphragm 20″ are distributed in a uniform two-dimensional grid.

The transmissive MEMS spatial filter 26 must then have a corresponding two-dimensional arrangement of pixels 28 so that a switchable pixel is assigned to each aperture 22″. The static spatial filter 44 and the spectrometer 46 must also be expanded accordingly in two dimensions, as is known in the prior art.

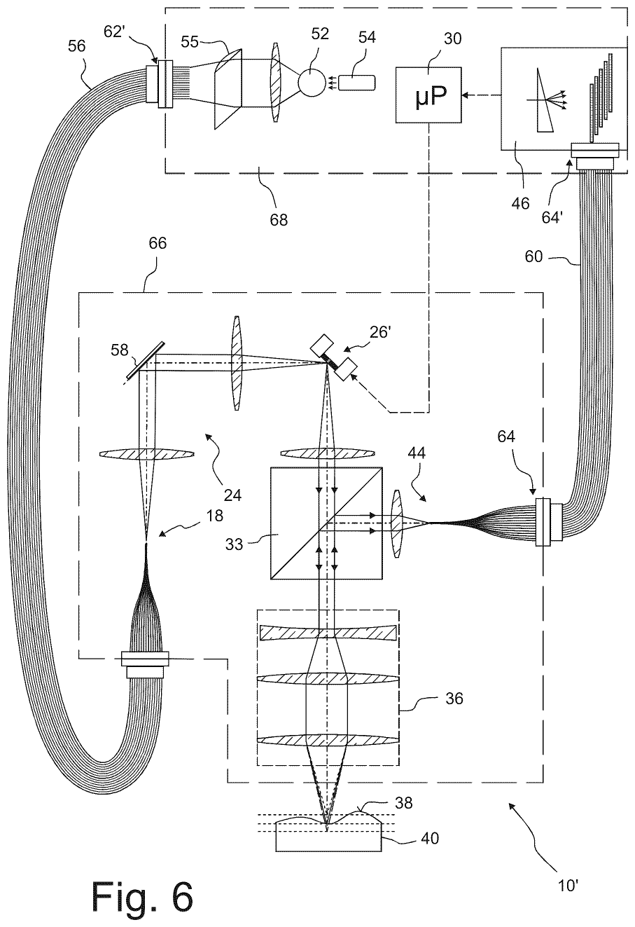

FIG. 6 shows a second embodiment of a measuring device, which is designated by 10′. This embodiment differs from the device 10 shown in FIG. 1 primarily in the following points:

Firstly, the light source 12 used is not a superluminescent diode, but a luminophore 52, which in the embodiment shown has an elongated light-emitting surface and is illuminated by a pump source 54, which may be a laser, for example. The polychromatic measuring light emerging from the light-emitting surface of the luminophore 52 is first collimated in the illustrated embodiment and then coupled into the ends of a linear arrangement of parallel optical fibers 56 with the aid of a cylindrical lens 55. A particularly high light intensity can be achieved with the luminophore 52. In one variant, the luminophore 52 has a round or square light-emitting surface. The ends of the optical fibers 56 then do not form a linear arrangement, but a round or square arrangement; the cylindrical lens 55 is omitted in this variant.

The measuring light ML guided in the optical fibers 56 emerges from the opposite ends of the fibers 56. These ends are arranged along a line running perpendicular to the paper plane and at the same time represent the light pattern generating device 18. The imaging optics 24 images the fiber ends via a flat deflecting mirror 58 onto a switchable spatial filter 26′, which is designed as a one-dimensional digital micromirror array (DMD, digital micromirror device) in the embodiment shown. The micromirror array extends perpendicular to the paper plane of FIG. 6.

In this embodiment, the static spatial filter 44 is also formed by a linear arrangement of ends of optical fibers 60, with the line also extending perpendicular to the paper plane in this case. The optical fibers 60 transmit the measured light to the spectrometer 46.

Optical fiber connectors 62, 62′, 64, 64′ can be integrated into the optical fibers 56, 60. In this way, the parts of the device 10′ outlined with dashed lines can be accommodated in separate housings, which form a mobile measuring head 66 and a stationary control unit 68.

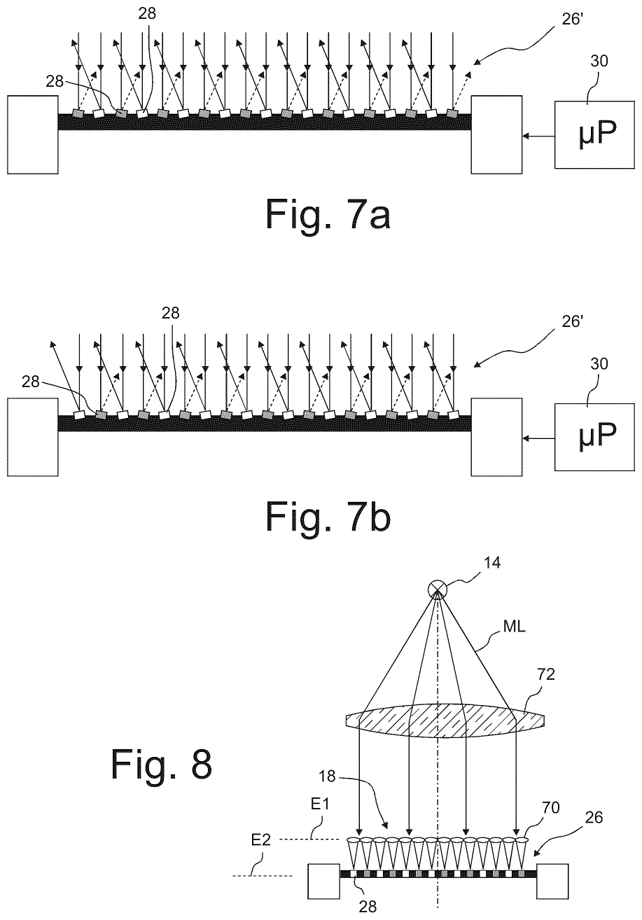

FIGS. 7a and 7b illustrate the two switching configurations of the reflective switchable spatial filter 26′ in representations based on FIGS. 3a and 3b. Each pixel 28 is formed by a micromirror that can assume two stable switching states. Pixels 28 with a gray background color are in the second switching state and reflect the incident measuring light ML so that it impinges on an absorber. The pixels 28 with a white background color reflect the incident measuring light ML so that it can enter the objective 36 via the beam splitter cube 33.

FIG. 8 illustrates a schematic representation of an embodiment in which the light pattern generating device 18 is formed by a linear arrangement of microlenses 70. The light source comprises a collimator lens 72, which directs the measurement light collimated onto the microlenses 70. Each of these focuses the measurement light ML onto an associated pixel 28 of the transmissive switchable spatial filter 26. In this embodiment, therefore, no imaging optics 24 are required. Since the microlenses 70 are arranged directly in front of the transmissive switchable spatial filter 26, the plane E1 of the microlenses 70 virtually coincides with the plane E2, which corresponds to optical conjugation. The numerical aperture NA of the microlenses 70 is adapted to the numerical aperture NA of the objective 36.

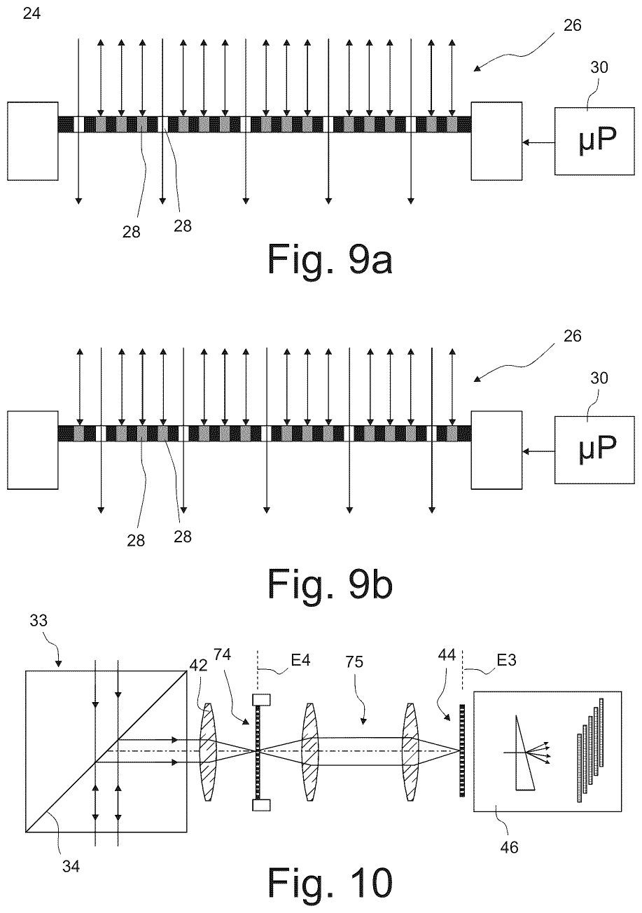

FIGS. 9a and 9b illustrate further possibilities for possible switching configurations in schematic representations based on FIGS. 3a and 3b. If the images of the point light sources at the height of the static spatial filter 44 are particularly large, these images may extend not only over the immediately adjacent apertures 22′, but over two or even three adjacent apertures 22′. In this case, the measurement should be divided into not two, but three or more individual measurements in order to prevent optical crosstalk.

In FIGS. 9a and 9b, it is assumed that a total of four individual measurements are provided. Of four pixels 28 adjacent along one direction, only one is therefore always in the second switching state in each switching configuration, while the other three pixels are in the first switching state and block the incident measuring light. Two of the four switching configurations to be set in succession are shown in FIGS. 9a and 9b.

FIG. 10 shows a section of another variant; the parts of the device 10 not shown in FIG. 10 correspond to those in FIG. 1.

In this variant, a further transmissive MEMS spatial filter 74 is arranged in the light path between the beam splitter cube 33 and the spectrograph 46 in a fourth plane E4, which is optically conjugated to the first plane E1 and the second plane E2. A further imaging optics 75 images the further transmissive MEMS spatial filter 74 in the plane E4 onto the static spatial filter 44 in the plane E3. The pixels of the further transmissive MEMS spatial filter 74 also have the property of being convertible into a first switching state, in which the pixel blocks measuring light ML, and into a second switching state, in which the pixel does not block measuring light ML. In one variant, the static spatial filter 44 is omitted; the input slit of the spectrograph 46 is then located in plane E3.

Such a further transmissive MEMS spatial filter 74 is advantageous if the input channels in the spectrograph cannot be deactivated individually and the images of the point light sources would partially overlap on the static spatial filter 44 despite the MEMS spatial filter 26 arranged at the front of the beam path behind the objective 34. The further transmissive MEMS spatial filter 74 “cleans up” the light distribution and in this way ensures that there is no overlap of the images of the point light sources on the static spatial filter 44.

The switching configurations of the further transmissive MEMS spatial filter 74 are always adapted to the switching configurations of the front transmissive MEMS spatial filter 26.

However, if the spectrograph has individually deactivatable input channels, the additional MEMS spatial filter 74 can be dispensed with.

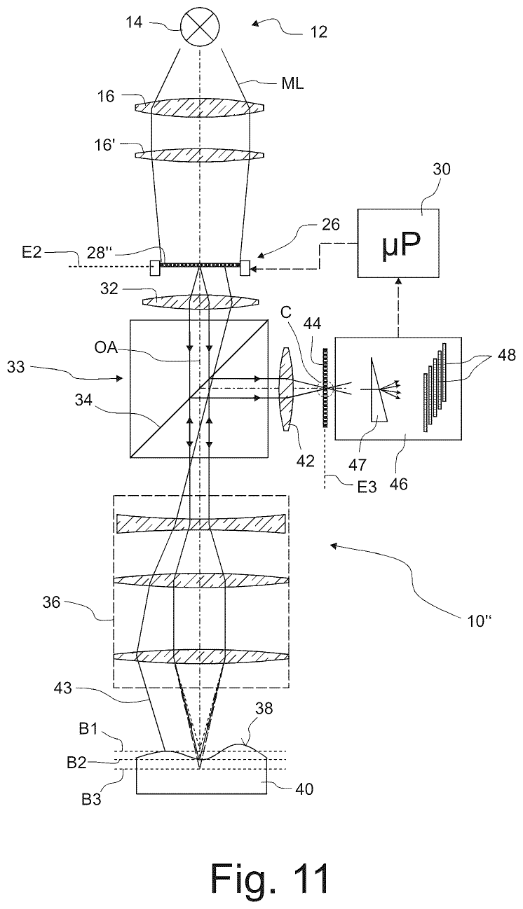

FIG. 11 shows a third embodiment of a measuring device, which is labeled 10″, in a representation based on FIG. 1. Whereas in the previously described embodiments the pixel-wise digitally switchable spatial filter 26, 26′ is an assembly independent of the light pattern generating device 18, in the device 10″ the pixel-wise digitally switchable spatial filter 26″ forms the light pattern generating device 18. As a result, no separate light pattern generating device is required, with the consequence that no imaging optics are required that image a light pattern generating device onto the pixel-wise digitally switchable spatial filter 26″.

In the device 10″, the measuring light ML generated by the light source 14 is initially collimated by a converging lens 16 in the embodiment shown. A further converging lens 16′ focuses the measuring light ML so that it just completely illuminates the pixel-wise digitally switchable spatial filter 26″. In FIG. 11, it is assumed that the pixel-wise digitally switchable spatial filter 26″ is square and that a circularly limited area is illuminated by the measuring light ML. In the case of a linear pixel-wise digitally switchable spatial filter, i.e. one that only extends along one direction, the converging lens 16′ can be designed as a cylindrical lens or as another anamophotic optical element that has a different refractive power along orthogonal directions. In this way, the linear spatial filter can be illuminated in stripes in order to minimize light losses. Alternatively, a light source with an elongated exit surface can be used, which is imaged onto the linear pixel-wise digitally switchable spatial filter and illuminates it accordingly.

What is claimed is:

1-15. (canceled)

16. A device for chromatic confocal measurement of distances to a plurality of points on a surface of an object, which at least partially reflects incident measuring light, the device comprising:
a) a light source configured to generate polychromatic measuring light;
b) a light pattern generating device configured to generate a light pattern from the measuring light, which extends in a first plane along one dimension or along two dimensions;
c) a chromatically uncorrected objective configured to generate images of the light pattern in image planes each with an axial position that is wavelength-dependent due to chromatic longitudinal aberration;
d) a static spatial filter, which is arranged in a second plane and has a filter function corresponding to the light pattern, the second plane being optically conjugate to the first plane;
e) a beam splitter cube, which is arranged in a light path between the light pattern generating device and the objective and directs measuring light, which has been reflected from the surface and has passed through the objective, to the static spatial filter;
f) a spectrometer including a plurality of input channels, which are each configured to spectrally analyze reflected measurement light, which has passed through a point of the static spatial filter assigned to the respective input channel;
g) an evaluation device configured to calculate distances from points on the surface to the device from wavelengths measured by the spectrometer; and
h) a pixel-wise digitally switchable spatial filter, which has a plurality of pixels and either forms the light pattern generating device or is arranged in a third plane, which is optically conjugate to the first plane and the second plane,
wherein each pixel can be converted into a first switching state, in which the pixel blocks measuring light, and into a second switching state, in which the pixel does not block measuring light.

17. The device of claim 16, wherein the pixel-wise digitally switchable spatial filter is configured to switch between a first switching configuration and a second switching configuration during a measurement, wherein, in the first switching configuration, no two adjacent pixels are in the same switching state, and wherein the second switching configuration is complementary to the first switching configuration.

18. The device of claim 16, wherein the pixel-wise digitally switchable spatial filter forms the light pattern generating device, and wherein the measuring light propagates between the light source and the pixel-wise digitally switchable spatial filter as a free beam.

19. The device of claim 16, wherein the pixel-wise digitally switchable spatial filter is distinct from the light pattern generating device and is arranged in the third plane.

20. The device of claim 19, wherein the pixel-wise digitally switchable spatial filter is located in a light path between the light pattern generating device and the beam splitter cube.

21. The device of claim 19, wherein the device comprises imaging optics, which image the first plane onto the third plane.

22. The device of claim 19, wherein the light pattern comprises a plurality of two-dimensionally distributed light points or at least one continuous light line or a light line composed of light points.

23. The device of claim 19, wherein the light pattern generating device comprises an array of ends of optical fibers.

24. The device of claim 19, wherein the light pattern generating device comprises a diaphragm having at least one opening.

25. The device of claim 19, wherein the light pattern generating device comprises a planar array of micro-converging lenses.

26. The device of claim 16, comprising a collimator that is arranged in a light path between the light pattern generating device and the beam splitter cube, wherein the collimator collimates measuring light entering the beam splitter cube.

27. The device of claim 16, wherein the pixel-wise digitally switchable spatial filter is a micromirror array.

28. The device of claim 16, wherein the polychromatic light source comprises a luminophore.

29. The device of claim 16, wherein the spectrometer is synchronized with the pixel-wise digitally switchable spatial filter in such a way that input channels, which are assigned to pixels in the second switching state, are deactivated.

30. The device of claim 16, wherein:
the pixel-wise digitally switchable spatial filter is arranged in a light path between the light source and the beam splitter cube;
a further pixel-wise digitally switchable spatial filter is arranged in a light path between the beam splitter cube and the spectrometer in a fourth plane, which is optically conjugate to the first plane and the second plane, and
each pixel of the further pixel-wise digitally switchable spatial filter is configured to be transferred into a first switching state, in which the pixel blocks measuring light, and into a second switching state, in which the pixel does not block measuring light.
